(19) United States
(12) Patent Application Publication
(10) Pub. No.: US 2023/0010861 A1
(43) Pub. Date: Jan. 12, 2023

(54) ELECTRIC CIRCUIT THAT SUPPLIES POWER TO POWER SUPPLY LINE UPON DETECTING POWER SUPPLY TO SIGNAL LINE, BUT RESTRICTS POWER SUPPLY TO POWER SUPPLY LINE WHEN POWER SUPPLY TO SIGNAL LINE IS NOT DETECTED, AND IMAGE FORMING APPARATUS

(71) Applicant: KYOCERA Document Solutions Inc., Osaka (JP)

(72) Inventor: Hitoshi HAYAMIZU, Osaka (JP)

(73) Assignee: KYOCERA Document Solutions Inc., Osaka (JP)

(21) Appl. No.: 17/857,653

(22) Filed: Jul. 5, 2022

(30) Foreign Application Priority Data
Jul. 8, 2021 (JP) 2021-113682

(51) Int. Cl. G03G 15/00; G03G 15/20

(52) U.S. Cl. CPC G03G 15/5004; G03G 15/205

(57) ABSTRACT

An electric circuit includes a power supply circuit that supplies electric power, a load, a power supply line that supplies the power from the power supply circuit to the load, a signal line located along and adjacent to the power supply line, a detector that detects whether the power is being supplied to the signal line, and a controller including a processor, and configured to, when the processor executes a control program, cause the power supply circuit to supply the power to the power supply line, in a case where the detector detects the power supply to the signal line when a signal is outputted to the signal line, and restrict the power supply circuit from supplying the power to the power supply line, in a case where the detector does not detect the power supply to the signal line.

### INCORPORATION BY REFERENCE

This application claims priority to Japanese Patent Application No. 2021-113682 filed on Jul. 8, 2021, the entire contents of which are incorporated by reference herein.

### BACKGROUND

The present disclosure relates to an electric circuit that detects a short circuit, and an image forming apparatus including the electric circuit.

Image forming apparatuses are widely known that include an image forming device that forms a toner image on a recording sheet according to a source image, and a fixing device that fixes the toner image onto the recording sheet, thus to print the image on the recording sheet. When an abnormal current flows in a heater, which is the heat source of a heating member, in the fixing device of the image forming apparatus configured as above, the heating member is excessively heated up, resulting in malfunction of the fixing device.

A first technique currently employed to avoid such a problem includes electrically disconnecting between a power supply controller and an electric heat generating body while the printing operation is not being executed, keeping the power supply only between a switcher and the heat generating body and detecting the temperature thereof in this state, and deciding that the power supply controller is malfunctioning upon detecting an increase in temperature.

In addition, a second technique is known that includes setting a target temperature of drying wind to a higher side, when temperature inside an air passage rises because of a suction fan of an ink jet printer being off, to ensure that the detected temperature of the drying wind reaches a permissible temperature, when a blower is not in operation during an initial operation period, thereby activating an overheating prevention device so as to disconnect power supply to the heater.

### SUMMARY

The disclosure proposes further improvement of the foregoing techniques.

In an aspect, the disclosure provides an electric circuit including a power supply circuit, a load, a power supply line, a signal line, a detector, and a controller. The power supply circuit supplies electric power. The power supply line supplies the power from the power supply circuit to the load. The signal line is located along and adjacent to the power supply line. The detector detects whether the power is being supplied to the signal line. The controller includes a processor, and operates, when the processor executes a control program, so as to cause the power supply circuit to supply the power to the power supply line, in a case where the detector detects the power supply to the signal line when a signal is outputted to the signal line, and restrict the power supply circuit from supplying the power to the power supply line, in a case where the detector does not detect the power supply to the signal line when the signal is outputted to the signal line.

In another aspect, the disclosure provides an image forming apparatus including an image forming device, and the foregoing electric circuit. The image forming device prints an image on a sheet.

### BRIEF DESCRIPTION OF THE DRAWINGS

FIG. 1 is a schematic cross-sectional view showing an internal configuration of an image forming apparatus;

FIG. 2 is a circuit diagram showing a configuration of a heater circuit and a disconnection detection circuit; and

FIG. 3 is a schematic drawing for explaining a structure of lines.

### DETAILED DESCRIPTION

Hereafter, an electric circuit and an image forming apparatus according to an embodiment of the disclosure will be described, with reference to the drawings. In the following embodiment, the image forming apparatus is exemplified by a laser printer that forms an image on a sheet, and applies heat treatment to the toner image, thereby printing the image. However, the image forming apparatus may be configured to perform a different printing method, for example using a heater.

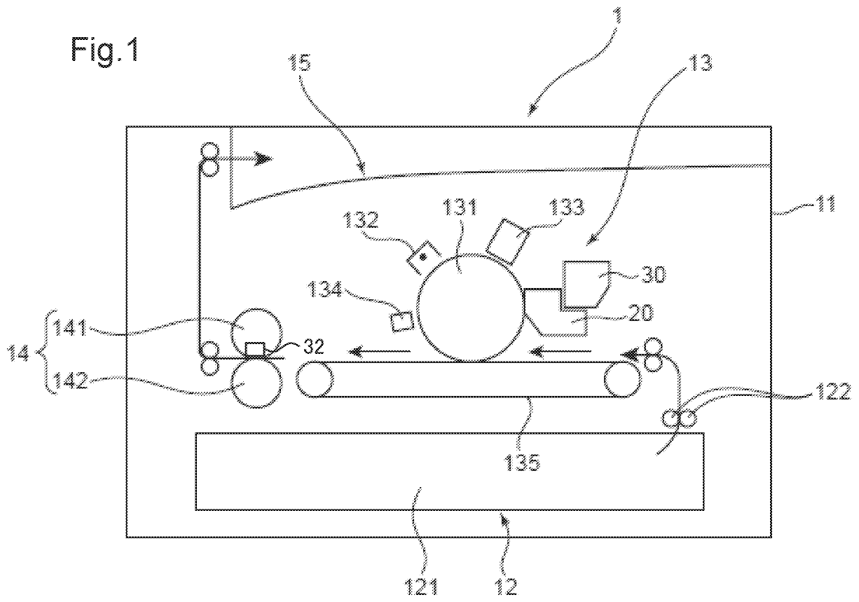

FIG. 1 schematically illustrates an internal configuration of the image forming apparatus 1 according to the disclosure. The image forming apparatus 1 includes, inside a main body 11, a paper feeding device 12 that delivers sheets stored therein as necessary, an image forming device 13 that forms a toner image on the sheet delivered from the paper feeding device 12, and a fixing device 14 that fixes the toner image formed by the image forming device 13, onto the sheet. The image forming apparatus 1 also includes an output tray 15 located on the upper face of the main body 11, and to which the sheet that has undergone the fixing process is delivered.

The image forming device 13 forms the toner image on the sheet delivered from the paper feeding device 12, by an electrophotography method. The image forming device 13 includes a photoconductor drum 131, and a charging device 132, an exposure device 133, a developing device 20, and a cleaning device 134, which are located around the photoconductor drum 131.

The developing device 20 supplies toner to the circumferential surface of the photoconductor drum 131, to form the toner image on the circumferential surface. A toner container 30 for storing the toner is attached to the developing device 20. The sheet is transported by transport rollers 122 from a paper tray 121 in the paper feeding device 12 toward an intermediate transfer belt 135, by which the toner image formed on the photoconductor drum 131 is transferred to the sheet.

The fixing device 14 fixes the toner image formed by the image forming device 13, onto the sheet. The fixing device 14 includes a heat roller 141 of a circular cylindrical shape, and a pressure roller 142 opposed to the heat roller 141. The pressure roller 142 is pressed against the heat roller 141, and defines a nip region where the sheet is pinched, in collaboration with the heat roller 141. The fixing device 14 fixes the toner image onto the sheet, by heating the sheet with pressure.

The heat roller 141 includes a built-in heater 32, so that the heat from the heater 32 is transmitted to the sheet via the heat roller 141.

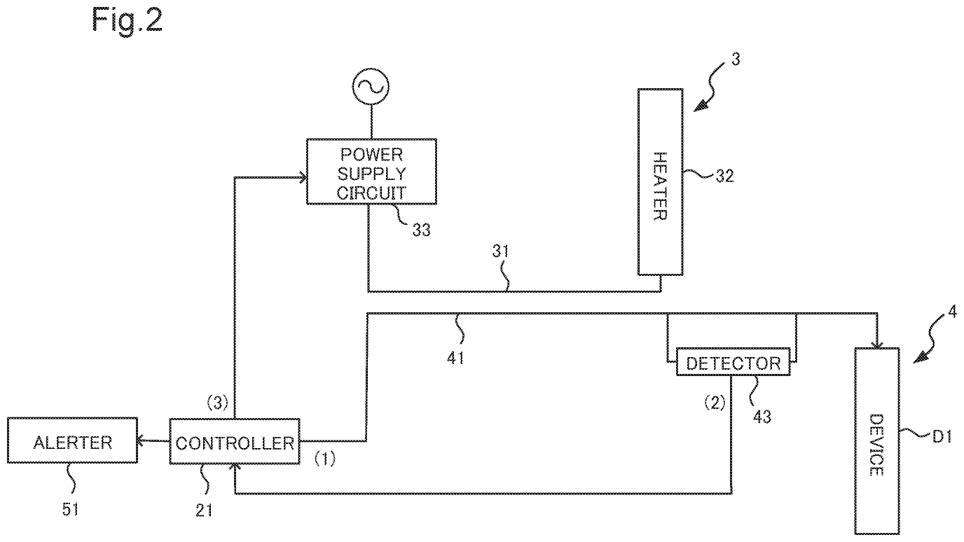

FIG. 2 illustrates a configuration of a heater circuit 3 and a disconnection detection circuit 4. The heater circuit 3 includes a power supply circuit 33 that supplies power, for example acquired from an AC power source, to a load, a heater 32 to which the power is supplied from the power supply circuit 33, and a power supply line 31 connecting between the power supply circuit 33 and the heater 32. The disconnection detection circuit 4 includes a controller 21, a signal line 41, a detector 43, and an alerter 51. The controller 21 and a device D1 are connected in series to each other, via the signal line 41. The detector 43 is connected to the signal line 41 between the controller 21 and the device D1. The signal line 41 of the disconnection detection circuit 4 is located along and adjacent to the power supply line 31 of the heater circuit 3. Here, the heater 32 exemplifies the load in the disclosure. The device D1 is one of the devices installed in the image forming apparatus 1. The heater circuit 3 and the disconnection detection circuit 4 exemplify the power supply circuit in the disclosure.

The controller 21 includes a processor, and controls the power supply circuit 33 and outputs a signal to the device D1, when the processor executes a control program. The detector 43 is, for example, constituted of a comparator. The detector 43 detects power supply to the signal line 41, and outputs a signal indicating whether the power is being supplied, to the controller 21.

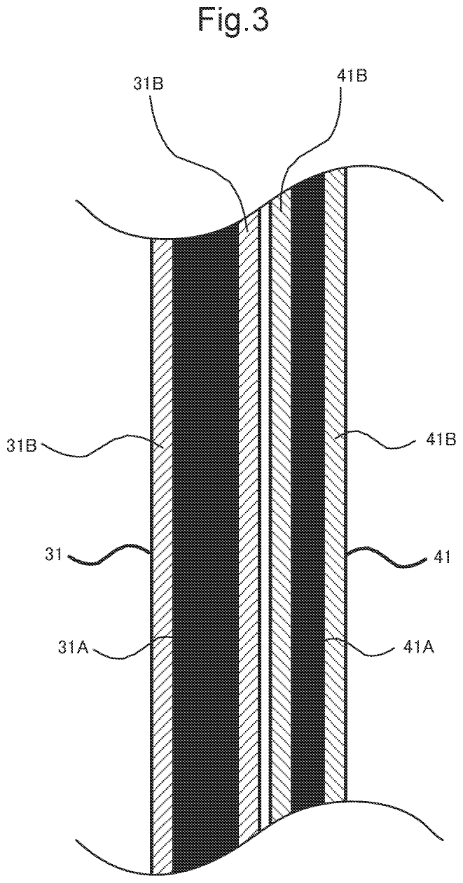

FIG. 3 is a schematic drawing for explaining the structure of the power supply line 31 and the signal line 41. The power supply line 31 includes a metal wire 31A for supplying the power, and an insulation film 31B. The signal line 41 includes a metal wire 41A for transmitting signals, and an insulation film 41B. The power supply line 31 and the signal line 41 parallelly extend close to each other, so that when the power supply line 31 is disconnected or semi-disconnected for some reason, the signal line 41 is also disconnected or semi-disconnected.

Referring again to FIG. 2, the controller 21 outputs a signal for driving the device D1, before causing the power supply circuit 33 to start the power supply ((1)). It is preferable that the device D1 is a device that is activated when the image forming apparatus 1 is activated. The controller 21 outputs the signal for driving the device D1 to the signal line 41, when the image forming apparatus 1 is activated. At this point, the detector 43 detects the power supply, unless the signal line 41 is disconnected, and outputs a signal indicating that the power is being supplied, to the controller 21 ((2)). When the signal outputted by the detector 43 indicates that the power is being supplied, the controller 21 causes the power supply circuit 33 to supply the power to the heater 32 through the power supply line 31 ((3)).

In the case where the signal line 41 is disconnected, when the controller 21 outputs the signal for driving the device D1 to the signal line 41 before causing the power supply circuit 33 to start the power supply ((1)), the detector 43 outputs a signal indicating that the power is not being supplied, to the controller 21 ((2)). When the signal outputted by the detector 43 indicates that the power is not being supplied, the controller 21 restricts the power supply circuit 33 from supplying the power to the heater 32 through the power supply line 31.

When the signal line 41 is disconnected, it is highly likely that the power supply line 31, running parallel to the signal line 41, is also disconnected. When the power supply circuit 33 supplies the power to the heater 32 in such a state, a large current runs because of a short circuit, resulting in breakdown of the apparatus.

Accordingly, as described above, the controller 21 outputs a signal to the signal line 41 running parallel to the power supply line 31, thereby confirming that the power is being supplied, and then supplies the power to the heater 32 through the power supply circuit 33. Such an arrangement prevents the breakdown of the apparatus arising from the short circuit.

When the signal outputted by the detector 43 indicates that the power is not being supplied, the controller 21 may output a signal to the alerter 51, including a display device such as a liquid crystal display (LCD). Upon receipt of the signal, the alerter 51 causes the display device to display a message to the effect that a trouble has occurred in the heater circuit 3. Otherwise, when the alerter 51 includes an illuminating device such as a light emitting diode (LED) lamp, the alerter 51 lights up the illuminating device to notify the trouble, according to the signal from the controller 21. Further, when the alerter 51 includes a speaker, the alerter 51 causes the speaker to output a warning sound for notifying the trouble, according to the signal from the controller 21.

Now, the aforementioned first and second techniques are designed to disconnect the power supply, when an increase in temperature is detected after the power is supplied to the electric heat generating body or heater. Therefore, when the wire on the primary side is disconnected, fuming or firing may take place owing to the temperature increase, which may lead to a serious trouble.

According to the foregoing embodiment, in contrast, the signal line 41 in the disconnection detection circuit 4 is running closely parallel to the power supply line 31 in the heater circuit 3, and therefore when the power supply line 31 is disconnected, the signal line 41 is also disconnected, with high probability. Accordingly, the disconnection of the power supply line 31 in the heater circuit 3 can be safely and easily detected, without supplying power to the power supply line 31, by detecting whether power is being supplied to the signal line 41. In addition, when it is detected that the power is not being supplied to the signal line 41, it is highly likely that the power supply line 31 is also detected, and therefore the controller 21 restricts the power supply circuit 33 from supplying the power. Such an arrangement prevents the breakdown of the apparatus arising from a large current that runs owing to a short circuit. Thus, the configuration according to the foregoing embodiment enables a short circuit of the wire on the primary side to be detected in advance, before supplying power to the load.

In the foregoing embodiment, the signal line for transmitting a signal to the device D1, which is one of the devices installed in the image forming apparatus 1, is employed as the signal line 41 for detecting disconnection of the power supply line 31. However, the disclosure is not limited to such an embodiment. For example, a signal line to be exclusively used to detect the disconnection of the power supply line 31 may be employed as the signal line 41 for detecting the disconnection of the power supply line 31.

The disclosure may be modified in various manners, without limitation to the configuration according to the foregoing embodiment. Although the load is exemplified by the heater 32 in the embodiment, the load may be one of other devices in the image forming apparatus 1. Further, although the heater circuit 3 and the disconnection detection circuit 4 are provided in the image forming apparatus 1 in the foregoing embodiment, these circuits may be provided in different electronic apparatuses, such as medical equipment.

The configurations and processings according to the foregoing embodiment, described with reference to FIG. 1 to FIG. 3, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An electric circuit comprising:
a power supply circuit that supplies electric power;
a load;
a power supply line that supplies the power from the power supply circuit to the load;
a signal line located along and adjacent to the power supply line;
a detector that detects whether the power is being supplied to the signal line; and
a controller including a processor, and configured to, when the processor executes a control program, cause the power supply circuit to supply the power to the power supply line, in a case where the detector detects the power supply to the signal line when a signal is outputted to the signal line, and restrict the power supply circuit from supplying the power to the power supply line, in a case where the detector does not detect the power supply to the signal line when the signal is outputted to the signal line.

2. The electric circuit according to claim 1, further comprising an alerter,
Wherein, when the detector does not detect the power supply to the signal line, the controller causes the alerter to announce occurrence of abnormality.

3. The electric circuit according to claim 1,
wherein the load includes a heater.

4. An image forming apparatus comprising:
an image forming device that prints an image on a sheet; and
the electric circuit according to claim 1.

5. The image forming apparatus according to claim 4, further comprising a device to be activated when the image forming apparatus is activated,
wherein the signal line is connected to the device, and
the controller outputs a signal to be transmitted to the device to the signal line, when the image forming apparatus is activated.

6. The image forming apparatus according to claim 4, further comprising:
a heat roller including therein a heater that serves as the load; and
a pressure roller pressed against the heat roller, and defining a nip region for pinching the sheet.
